(19) United States
(12) Patent Application Publication
(10) Pub. No.: US 2018/0268292 A1
(43) Pub. Date: Sep. 20, 2018

(54) LEARNING EFFICIENT OBJECT DETECTION MODELS WITH KNOWLEDGE DISTILLATION

(71) Applicant: NEC Laboratories America, Inc., Princeton, NJ (US)

(72) Inventors: Wongun Choi, Lexington, MA (US); Manmohan Chandraker, Santa Clara, CA (US); Guobin Chen, San Jose, CA (US); Xiang Yu, Mountain View, CA (US)

(73) Assignee: NEC Laboratories America, Inc., Princeton, NJ (US)

(21) Appl. No.: 15/908,870

(22) Filed: Mar. 1, 2018

Related U.S. Application Data
(60) Provisional application No. 62/472,841, filed on Mar. 17, 2017.

(51) Int. Cl. G06N 3/08; G06K 9/66

(52) U.S. Cl. CPC G06N 3/08; G06K 9/66

(57) ABSTRACT

A computer-implemented method executed by at least one processor for training fast models for real-time object detection with knowledge transfer is presented. The method includes employing a Faster Region-based Convolutional Neural Network (R-CNN) as an objection detection framework for performing the real-time object detection, inputting a plurality of images into the Faster R-CNN, and training the Faster R-CNN by learning a student model from a teacher model by employing a weighted cross-entropy loss layer for classification accounting for an imbalance between background classes and object classes, employing a boundary loss layer to enable transfer of knowledge of bounding box regression from the teacher model to the student model, and employing a confidence-weighted binary activation loss layer to train intermediate layers of the student model to achieve similar distribution of neurons as achieved by the teacher model.

### RELATED APPLICATION INFORMATION

This application claims priority to Provisional Application No. 62/472,841, filed on Mar. 17, 2017, incorporated herein by reference in its entirety.

### BACKGROUND

### Technical Field

The present invention relates to neural networks and, more particularly, to learning efficient object detection models with knowledge distillation in neural networks.

### Description of the Related Art

Recently there has been a tremendous increase in the accuracy of object detection by employing deep convolutional neural networks (CNNs). This has made visual object detection an attractive possibility for domains ranging from surveillance to autonomous driving. However, speed is a key requirement in many applications, which fundamentally contends with demands on accuracy. Thus, while advances in object detection have relied on increasingly deeper architectures, such architectures are associated with an increase in computational expense at runtime.

### SUMMARY

A computer-implemented method executed by at least one processor for training fast models for real-time object detection with knowledge transfer is presented. The method includes employing a Faster Region-based Convolutional Neural Network (R-CNN) as an objection detection framework for performing the real-time object detection, inputting a plurality of images into the Faster R-CNN, and training the Faster R-CNN by learning a student model from a teacher model by employing a weighted cross-entropy loss layer for classification accounting for an imbalance between background classes and object classes, employing a boundary loss layer to enable transfer of knowledge of bounding box regression from the teacher model to the student model, and employing a confidence-weighted binary activation loss layer to train intermediate layers of the student model to achieve similar distribution of neurons as achieved by the teacher model.

A system for training fast models for real-time object detection with knowledge transfer is also presented. The system includes a memory and a processor in communication with the memory, wherein the processor is configured to employ a Faster Region-based Convolutional Neural Network (R-CNN) as an objection detection framework for performing the real-time object detection, input a plurality of images into the Faster R-CNN, and train the Faster R-CNN by learning a student model from a teacher model by: employing a weighted cross-entropy loss layer for classification accounting for an imbalance between background classes and object classes, employing a boundary loss layer to enable transfer of knowledge of bounding box regression from the teacher model to the student model, and employing a confidence-weighted binary activation loss layer to train intermediate layers of the student model to achieve similar distribution of neurons as achieved by the teacher model.

A non-transitory computer-readable storage medium comprising a computer-readable program is presented for training fast models for real-time object detection with knowledge transfer, wherein the computer-readable program when executed on a computer causes the computer to perform the steps of employing a Faster Region-based Convolutional Neural Network (R-CNN) as an objection detection framework for performing the real-time object detection, inputting a plurality of images into the Faster R-CNN, and training the Faster R-CNN by learning a student model from a teacher model by employing a weighted cross-entropy loss layer for classification accounting for an imbalance between background classes and object classes, employing a boundary loss layer to enable transfer of knowledge of bounding box regression from the teacher model to the student model, and employing a confidence-weighted binary activation loss layer to train intermediate layers of the student model to achieve similar distribution of neurons as achieved by the teacher model.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a knowledge distillation structure, in accordance with embodiments of the present invention;

FIG. 2 is a block/flow diagram illustrating a real-time object detection framework, in accordance with embodiments of the present invention;

FIG. 3 is a block/flow diagram illustrating a Faster Region-based convolutional neural network (R-CNN), in accordance with embodiments of the present invention;

FIG. 4 is a block/flow diagram illustrating a method for training fast models for real-time object detection with knowledge transfer, in accordance with embodiments of the present invention;

FIG. 5 is an exemplary processing system for training fast models for real-time object detection with knowledge transfer, in accordance with embodiments of the present invention;

FIG. 6 is a block/flow diagram of a method for training fast models for real-time object detection with knowledge transfer in Internet of Things (IoT) systems/devices/infrastructure, in accordance with embodiments of the present invention; and

FIG. 7 is a block/flow diagram of exemplary IoT sensors used to collect data/information related to training fast models for real-time object detection with knowledge transfer, in accordance with embodiments of the present invention.

### DETAILED DESCRIPTION OF PREFERRED EMBODIMENTS

In the exemplary embodiments of the present invention, methods and devices for implementing deep neural networks are introduced. Deep neural networks have recently exhibited state-of-the-art performance in computer vision tasks such as image classification and object detection. Moreover, recent knowledge distillation approaches are aimed at obtaining small and fast-to-execute models, and such approaches have shown that a student network could imitate a soft output of a larger teacher network or ensemble of networks. Thus, knowledge distillation approaches have been incorporated into neural networks.

While deeper networks are easier to train, tasks such as object detection for a few categories might not necessarily need such model capacity. As a result, several conventional techniques in image classification employ model compression, where weights in each layer are decomposed, followed by layer-wise reconstruction or fine-tuning to recover some of the accuracy. This results in significant speed-ups, but there is often a gap between the accuracies of original and compressed models, which can be large when using compressed models for more complex problems such as object detection. On the other hand, knowledge distillation techniques illustrate that a shallow or compressed model trained to mimic a behavior of a deeper or more complex model can recover some or all of the accuracy drop.

In the exemplary embodiments of the present invention, a method for training fast models for object detection with knowledge transfer is introduced. First, a weighted cross entropy loss layer is employed for classification that accounts for an imbalance in the impact of misclassification for background classes as opposed to between object classes. Next, a prediction vector of a bounding box regression of a teacher model is employed as a target for a student model, through an L2 boundary loss. Further, under-fitting is addressed by employing a binary activation loss layer for intermediate layers that allows gradients that account for the relative confidence of teacher and student models. Moreover, adaptation layers can be employed for domain specific fitting that allows student models to learn from distribution of neurons in the teacher model.

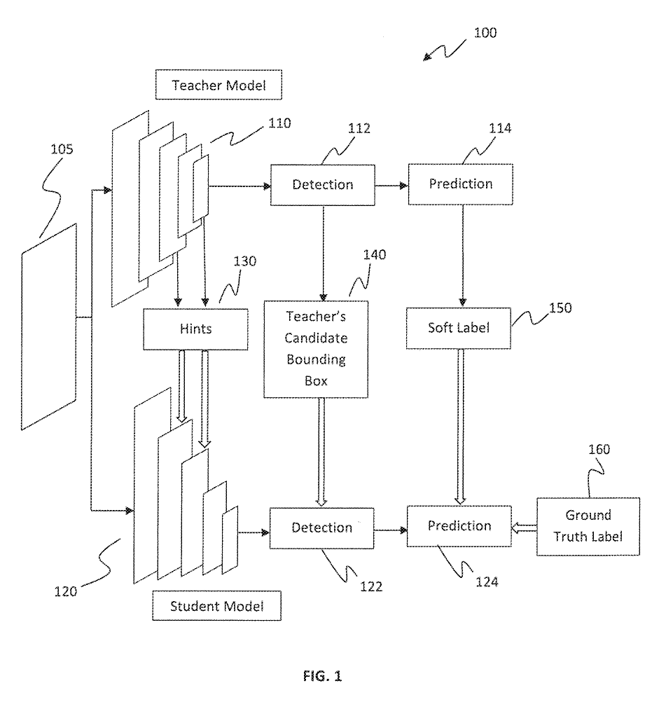

FIG. 1 is a block/flow diagram 100 illustrating a knowledge distillation structure, in accordance with embodiments of the present invention.

A plurality of images 105 are input into the teacher model 110 and the student model 120. Hint learning module 130 can be employed to aid the student model 120. The teacher model 110 interacts with a detection module 112 and a prediction module 114, and the student model 120 interacts with a detection module 122 and a prediction module 124. Bounding box regression module 140 can also be used to adjust a location and a size of the bounding box. The prediction modules 114, 116 communicate with soft label module 150 and ground truth module 160.

The teacher model 110 and the student model 120 are models that are trained to output a predetermined output with respect to a predetermined input, and may include, for example, neural networks. A neural network refers to a recognition model that simulates a computation capability of a biological system using a large number of artificial neurons being connected to each other through edges. It is understood, however, that the teacher model 110 and student model 120 are not limited to neural networks, and may also be implemented in other types of networks and apparatuses.

The neural network uses artificial neurons configured by simplifying functions of biological neurons, and the artificial neurons may be connected to each other through edges having connection weights. The connection weights, parameters of the neural network, are predetermined values of the edges, and may also be referred to as connection strengths. The neural network may perform a cognitive function or a learning process of a human brain through the artificial neurons. The artificial neurons may also be referred to as nodes.

A neural network may include a plurality of layers. For example, the neural network may include an input layer, a hidden layer, and an output layer. The input layer may receive an input to be used to perform training and transmit the input to the hidden layer, and the output layer may generate an output of the neural network based on signals received from nodes of the hidden layer. The hidden layer may be disposed between the input layer and the output layer. The hidden layer may change training data received from the input layer to an easily predictable value. Nodes included in the input layer and the hidden layer may be connected to each other through edges having connection weights, and nodes included in the hidden layer and the output layer may also be connected to each other through edges having connection weights. The input layer, the hidden layer, and the output layer may respectively include a plurality of nodes.

The neural network may include a plurality of hidden layers. A neural network including the plurality of hidden layers may be referred to as a deep neural network. Training the deep neural network may be referred to as deep learning. Nodes included in the hidden layers may be referred to as hidden nodes. The number of hidden layers provided in a deep neural network is not limited to any particular number.

The neural network may be trained through supervised learning. Supervised learning refers to a method of providing input data and output data corresponding thereto to a neural network, and updating connection weights of edges so that the output data corresponding to the input data may be output. For example, a model training apparatus may update connection weights of edges among artificial neurons through a delta rule and error back-propagation learning.

Error back-propagation learning refers to a method of estimating a loss with respect to input data provided through forward computation, and updating connection weights to reduce a loss in a process of propagating the estimated loss in a backward direction from an output layer toward a hidden layer and an input layer. Processing of the neural network may be performed in an order of the input layer, the hidden layer, and the output layer. However, in the error back-propagation learning, the connection weights may be updated in an order of the output layer, the hidden layer, and the input layer. Hereinafter, according to an exemplary embodiment, training a neural network refers to training parameters of the neural network. Further, a trained neural network refers to a neural network to which the trained parameters are applied.

The teacher model 110 and the student model 120 may be neural networks of different sizes which are configured to recognize the same target. It is understood, however, that the teacher model 110 and the student model 120 are not required to be different sizes.

The teacher model 110 is a model that recognizes target data with a relatively high accuracy based on a sufficiently large number of features extracted from target data to be recognized. The teacher model 110 may be a neural network of a greater size than the student model 120. For example, the teacher model 110 may include a larger number of hidden layers, a larger number of nodes, or a combination thereof, compared to the student model 120.

The student model 120 may be a neural network of a smaller size than the teacher model 110. Due to the relatively small size, the student model 120 may have a higher recognition rate than the teacher model 110. The student model 120 may be trained using the teacher model 110 to provide output data of the teacher model 110 with respect to input data. For example, the output data of the teacher model 110 may be a value of logic output from the teacher model 110, a probability value, or an output value of a classifier layer derived from a hidden layer of the teacher model 110. Accordingly, the student model 120 having a higher recognition rate than the teacher model 110 while outputting the same value as that output from the teacher model 110 may be obtained. The foregoing process may be referred to as model compression. Model compression is a scheme of training the student model 120 based on output data of the teacher model 110, instead of training the student model 120 based on correct answer data corresponding to a true label.

A plurality of teacher models 110 may be used to train the student model 120. At least one teacher model may be selected from the plurality of teacher models 110 and the student model 120 may be trained using the selected at least one teacher model. A process of selecting at least one teacher model from the plurality of teacher models 110 and training the student model 120 may be performed iteratively until the student model 120 satisfies a predetermined condition. In this example, at least one teacher model selected to be used to train the student model 120 may be newly selected each time a training process is performed. For example, one or more teacher models may be selected to be used to train the student model 120.

Additionally, each item in a batch can be classified by obtaining its feature set and then executing each classifier in a set of existing classifiers on such feature set, thereby producing corresponding classification predictions. Such predictions are intended to predict the ground truth label 160 that would be identified for the corresponding item if the item were to be classified manually. In the present embodiments, the “ground truth label” 160 (sometimes referred to herein simply as the label) represents a specific category (hard label) into which the specific item should be placed. Depending upon the particular embodiment, the classification predictions either identify particular categories to which the corresponding item should be assigned (sometimes referred to as hard classification predictions) or else constitute classification scores which indicate how closely related the items are to particular categories (sometimes referred to as soft classification predictions). Such a soft classification prediction preferably represents the probability that the corresponding item belongs to a particular category. It is noted that either hard or soft classification predictions can be generated irrespective of whether the ground truth labels are hard labels or soft labels, although often the predictions and labels will be of the same type.

In one exemplary embodiment, a classification approach can be used to train a classifier on known emotional responses. The video or image sequences of one or more subjects exhibiting an emotion or behavior are labeled based on ground truth labeling 160. These labels are automatically generated for video sequences capturing a subject after the calibration task is used to trigger an emotion. Using the classification technique, the response time, difficulty level of the calibration task, and the quality of the response to the task can be used as soft-labels 150 for indicating the emotion. The ground truth data is used in a learning stage that trains the classifier for detecting future instances of such behaviors (detection stage). Features and metrics can be extracted from the subjects during both the learning and detection stages.

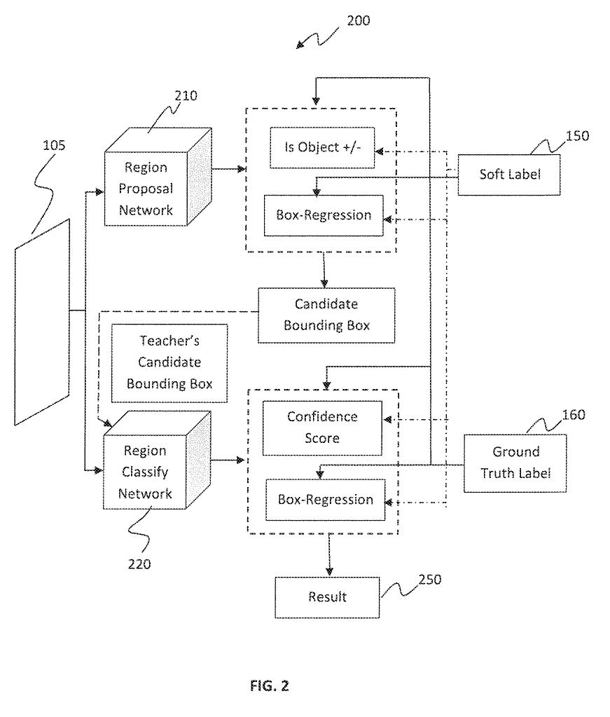

FIG. 2 is a block/flow diagram 200 illustrating a real-time object detection framework, in accordance with embodiments of the present invention.

The diagram 200 includes a plurality of images 105 input into the region proposal network 210 and the region classification network 220. Processing involving soft labels 150 and ground truth labels 160 can aid the region proposal network 210 and the region classification network 220 in obtaining desired results 250.

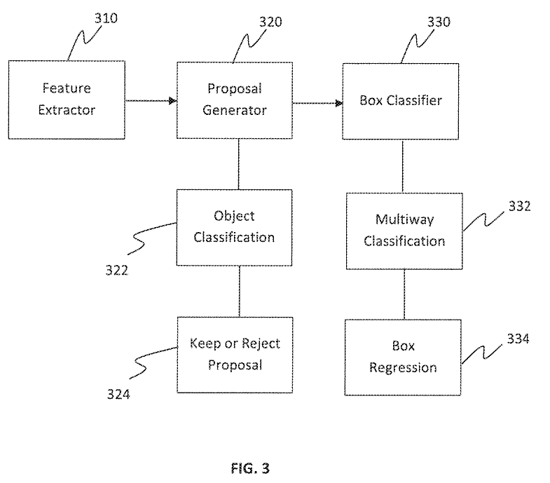

FIG. 3 is a block/flow diagram illustrating a Faster Region-based convolutional neural network (R-CNN), in accordance with embodiments of the present invention.

In the exemplary embodiments of the present invention, the Faster R-CNN can be adopted as the object detection framework. Faster R-CNN can include three modules, that is, a feature extractor 310, a proposal or candidate generator 320, and a box classifier 330. The feature extractor 310 allows for shared feature extraction through convolutional layers. The proposal generator 320 can be, e.g., a region proposal network (RPN) 210 that generates object proposals. The proposal generator 320 can include an object classification module 322 and a module 324 that is to keep or reject the proposal. The box classifier 330 can be, e.g., a classification and regression network (RCN) 220 that returns a detection score of the region. The box classifier 330 can include a multiway classification module 332 and a box regression module 334.

In order to achieve highly accurate object detection results 250, it is necessary to learn strong models for all the three components 310, 320, 330. Strong but efficient student object detectors are learned by using the knowledge of a high capacity teacher detection networks in all the three components 310, 320, 330.

Firstly, hint based learning can be employed that encourages a feature representation of a student network/model that is similar to that of the teacher network/model. A new loss function, e.g., a Binary Activation Loss function or layer, is employed that is more stable than L2 and puts more weight on activated neurons. Secondly, stronger classification modules are learned in both RPN 210 and RCN 220 by using the knowledge distillation framework of FIG. 1. In order to handle category imbalance issues in object detection, a weighted cross entropy loss layer is applied for the distillation framework of FIG. 1. Finally, the teacher's regression output is transferred as a form of upper bound, e.g., if the student's regression output is better than that of teacher, no loss is applied.

The overall learning objective can be written as follow:

L_{RPN}=L_{RPN}^{CLS}+L_{hard}^{REG}+λ₂L_{loc}^{REG}

L_{RCN}=L_{RPN}^{CLS}+L_{hard}^{REG}+λ₂L_{loc}^{REG}

L=L_{RPN}+L_{RCN}+L_{Hint} (1)

Where L_{RPN}^{CLS}, L_{RCN}^{CLS} denotes the loss function defined in Eq. 2, L_{Hint}, denotes the loss function defined in Eq. 5, L_{loc}^{REG} is defined in Eq. 4 and L_{hard}^{REG} is the Smooth L1.

Knowledge distillation classification is introduced for training a classification network by using predictions of the teacher networks to guide the training of the student model. Assume the following dataset {xᵢ,yᵢ}, i=1, 2, . . . , n where xᵢ∈ [symbol] is the input image and yᵢ∈ [symbol] is the label of the image.

Let t be the teacher model,

$${P}_{t} = softmax ( \frac{Z}{T} )$$

represent a prediction of the teacher model, while Z is an output of the last layer in t.

Similarly for the student network, assume:

$${P}_{s} = softmax ( \frac{V}{T} ) .$$

The student network is trained to optimize the following loss function:

L_{CLS}=λL_{hard}(Pₛ,y)+(1−λ)L_{soft}(Pₛ,Pₜ) (2)

where λ is the parameter to balance the hard loss and soft loss.

In conventional frameworks, both losses are cross entropy losses. Since Pt might be very close to the hard label, i.e., most of the probabilities are very close to 0. Conventional frameworks further introduced temperature parameter T to soften an output of the networks, which forces the production of a probability vector with relatively large values for each class. By learning from the soft label 150, the student network 120 could determine how the teacher network 110 tends to generalize and learn the relationship between different classes.

However, the process is different for the detection task. Although conventional works have proven that using L2 loss to match the logits before softmax is only a special case of distillation in a high temperature case, other conventional works have reported that L2 loss works better than the softened cross entropy loss for detection. The same phenomenon can be seen in experiments conducted employing the exemplary embodiments of the present invention. One cause of this is a difference between image classification and object detection. In image classification, the only error is misclassification, e.g., misclassify “cat” in an image as a “dog.” However, in object detection, failing to distinguish background/foreground and inaccurate localization dominate the error, while a proportion of misclassification between different classes is not very large. On one hand, the soft labels 150 are still useful for object detection since they contain richer information about the extent of being a background/foreground. On the other hand, soft labels 150 can be quite noisy at high temperatures since they may provide misleading information of being another object.

To address this, the following class-weighted cross entropy loss is employed:

L_{soft}(Pₛ,Pₜ)=−Σw_{c}Pₜ log Pₛ (3)

where Eq. (3) can use a larger weight for the background class and a relatively small weight for the other classes.

Regarding bounding box regression, apart from the classification layer, Faster R-CNN also employs bounding-box regression to adjust a location and a size of an input bounding box. The label of the bounding-box regression is the offsets of the input bounding-box and the ground truth. Learning from the teacher's prediction may not be reasonable since it does not contain information from other classes or backgrounds. A good way to make use of the teacher's prediction is to use it as the boundary of the student network. The prediction vector of bounding-box regression should be as close to the label as possible, or at least should be closer than the teacher's prediction.

By following this technique, L2 with boundary loss to transfer knowledge is given as:

L_{REG}= [symbol] (∥Rₛ−y_{loc}∥₂²+α>∥Rₜ−y_{loc}∥₂²) (∥lₛ−y_{loc}∥₂²+∥lₛ−lₜ∥₂²) (4)

where [symbol] (⋅) is the indicator function, a is the margin parameter, y_{loc} denotes the regression label, Rs is the prediction of student network for regression task, Rs is the prediction of teacher network 110.

Therefore, the network is penalized only when the error of the student network 120 is larger than that of the teacher network 110.

Regarding hint learning, distillation only transfers knowledge from the last layer. In conventional works, it has been indicated that employing the intermediate representation of the teacher model 110 as hints can improve the training process and final performance of the student model 120.

Such works use L2 distance between feature vector V and Z, L_{Hint}(V, Z)=∥V−Z∥₂², to mimic the response of teacher model 110.

The L2 loss takes each logits equally even from negative logits which will not be activated. When the teacher model 110 is more confident that the student model 120, a positive gradient should be passed to previous layers, otherwise a negative gradient is passed to previous layers.

Following this principle, the exemplary embodiments employ a Binary Activation loss, which learns according to the confidence of logit:

$${L}_{Hint} = ( {Z}_{i} < 0 ) \cdot {V}_{i} \cdot ( \frac{1 + sgn ( {V}_{i} ) )}{2} ) + ( {Z}_{i} \geq 0 ) ( {V}_{i} \geq {Z}_{i} ) ( {V}_{i} - {Z}_{i} ) \qquad ( 5 )$$

where [symbol] (⋅) is the indicator function, sgn(⋅) is the sign function, Vi is one neuron in student's network and Zi is one neuron in teacher's network 110.

Note that the input for Binary Activation loss should be before the rectified linear unit (ReLu) layer.

Distillation tends to solve the problem of generalization, in other words, the over-fitting problem. However, for shallower networks, the networks can also face an “under-fitting” problem. It's not easy for a shallow network to find the local minimal. Nevertheless, learning from hints could help the student model 120 converge faster. An adaption layer to map from layer Ls in student network 120 to layer Lt in teacher network 110 can be employed, even if the number of neurons are the same. The adaption layers serve as domain specific fittings, which could help the student model 120 learn a distribution of neurons in the teacher model 110 instead of from a direct response of each neuron.

Finally, regarding teacher and student networks 110, 120, in the exemplary embodiments of the present invention, Faster R-CNN can be employed as the model for real-time object detection. The detection includes shared convolutional layers, a Region Proposal Network (RPN) and a Region Classification Network (RCN). Each network includes a classification task and a regression task. Moreover, in the application of object detection, several important cues under the knowledge distillation framework are introduced to simplify the network structures and preserve the performance of the networks. A new objective loss layer for the output feature to better match the source feature space is introduced for the knowledge distillation. Further, the adaptive domain transfer layer is introduced to regularize both the final output and intermediate layers of the student models 120. Thus, knowledge distillation and hint learning can be employed to generate the object detection area.

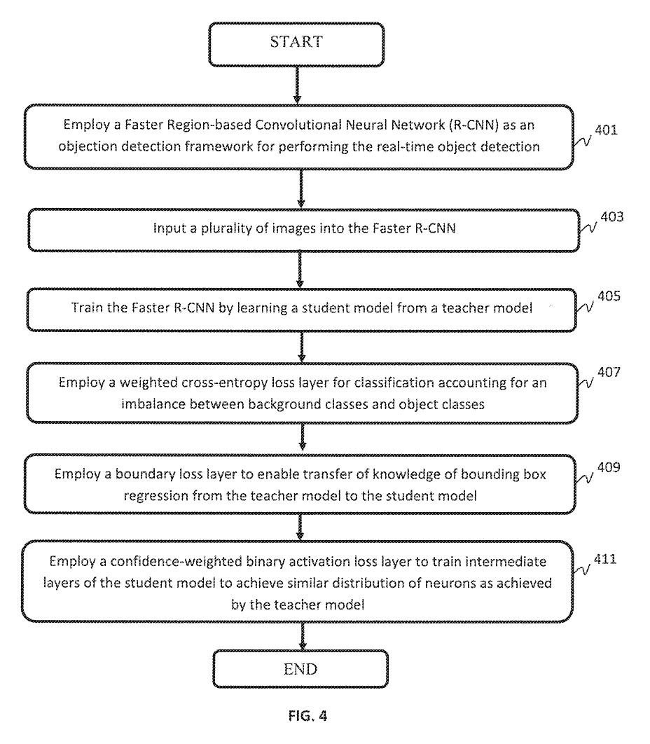

FIG. 4 is a block/flow diagram illustrating a method for training fast models for real-time object detection with knowledge transfer, in accordance with embodiments of the present invention.

At block 401, a Faster Region-based Convolutional Neural Network (R-CNN) is employed as an objection detection framework for performing the real-time object detection.

At block 403, a plurality of images are input into the Faster R-CNN.

At block 405, the Faster R-CNN is trained by learning a student model from a teacher model by blocks 407, 409, 411.

At block 407, a weighted cross-entropy loss layer is employed for classification accounting for an imbalance between background classes and object classes.

At block 409, a boundary loss layer is employed to enable transfer of knowledge of bounding box regression from the teacher model to the student model.

At block 411, a confidence-weighted binary activation loss layer is employed to train intermediate layers of the student model to achieve similar distribution of neurons as achieved by the teacher model.

Networks can represent all sorts of systems in the real world. For example, the Internet can be described as a network where the nodes are computers or other devices and the edges are physical (or wireless, even) connections between the devices. The World Wide Web is a huge network where the pages are nodes and links are the edges. Other examples include social networks of acquaintances or other types of interactions, networks of publications linked by citations, transportation networks, metabolic networks, communication networks, and Internet of Things (IoT) networks. The exemplary embodiments of the present invention can refer to any such networks without limitation.

In summary, the exemplary embodiments of the present invention solve the problem of achieving object detection at an accuracy comparable to complex deep learning models, while maintaining speeds similar to a simpler deep learning model. The exemplary embodiments of the present invention also address the problem of achieving object detection accuracy comparable to high resolution images, while retaining the speed of a network that accepts low resolution images. The exemplary embodiments of the present invention introduce a framework for distillation in deep learning for complex object detection tasks that can transfer knowledge from a network with a large number of parameters to a compressed one. A weighted cross-entropy loss layer is employed that accounts for imbalance between background and other object classes. An L2 boundary loss layer is further employed to achieve distillation for bounding box regression. Also, a binary activation loss layer is employed to address the problem of under-fitting.

Moreover, the advantages of the exemplary embodiments are at least as follows: the exemplary embodiments retain accuracy similar to a complex model, while achieving speeds similar to a compressed model, the exemplary embodiments can achieve accuracy similar to high resolution images while working with low resolution images, resulting in a significant speedup, and the exemplary embodiments can transfer knowledge from a deep model to a shallower one, allowing for faster speeds at the same training effort. Further advantages of the exemplary embodiments include the ability to design an effective framework that can transfer knowledge from a more expensive model to a cheaper one, allowing faster speed with minimal loss in accuracy, the ability to learn from low resolution images by mimicking the behavior of a model trained on high resolution images, allowing high accuracy at lower computational cost, taking into consideration imbalances between classes in detection that allows for accuracy improvement by weighing the importance of the background class, bounding box regression that allows transferring knowledge of better localization accuracy, and better training of intermediate layers through confidence-weighted binary activation loss that allows for higher accuracy.

Therefore, the framework allows for transferring knowledge from a more complex deep model to a less complex one. This framework is introduced for the complex task of object detection, by employing a novel weighted cross-entropy loss layer to balance the effects of background and other object classes, an L2 boundary loss layer to transfer the knowledge of bounding box regression from the teacher model to the student model, and a confidence-weighted binary activation loss to more effectively train the intermediate layers of the student model to achieve similar distribution of neurons as the teacher model.

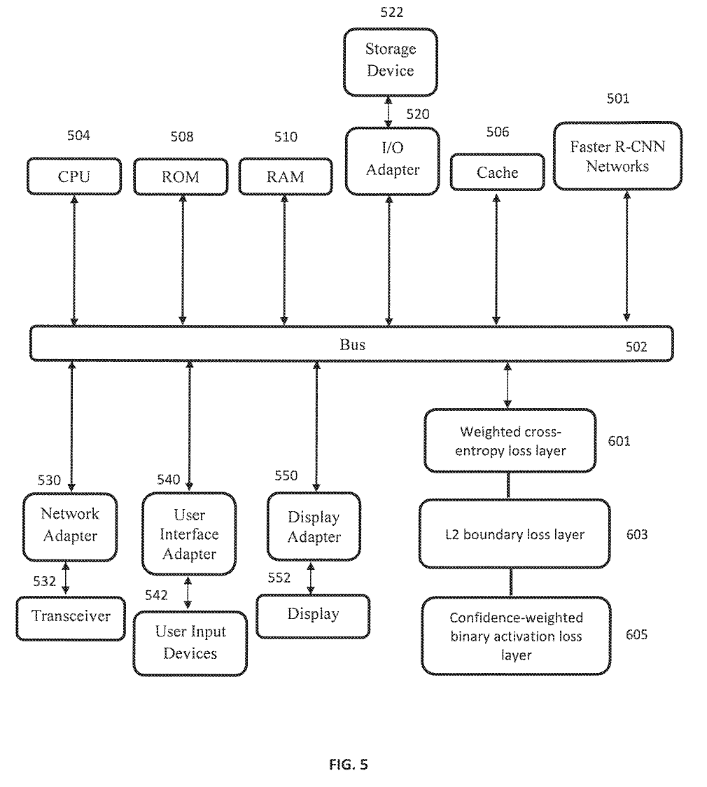

FIG. 5 is an exemplary processing system for training fast models for real-time object detection with knowledge transfer, in accordance with embodiments of the present invention.

The processing system includes at least one processor (CPU) 504 operatively coupled to other components via a system bus 502. A cache 506, a Read Only Memory (ROM) 508, a Random Access Memory (RAM) 510, an input/output (I/O) adapter 520, a network adapter 530, a user interface adapter 540, and a display adapter 550, are operatively coupled to the system bus 502. Additionally, a Faster R-CNN network 501 for employing object detection is operatively coupled to the system bus 502. The Faster R-CNN 501 achieves object detection by employing a weighted cross-entropy loss layer 601, an L2 boundary loss layer 603, and a confidence-weighted binary activation loss layer 605.

A storage device 522 is operatively coupled to system bus 502 by the I/O adapter 520. The storage device 522 can be any of a disk storage device (e.g., a magnetic or optical disk storage device), a solid state magnetic device, and so forth.

A transceiver 532 is operatively coupled to system bus 502 by network adapter 530.

User input devices 542 are operatively coupled to system bus 502 by user interface adapter 540. The user input devices 542 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 542 can be the same type of user input device or different types of user input devices. The user input devices 542 are used to input and output information to and from the processing system.

A display device 552 is operatively coupled to system bus 502 by display adapter 550.

Of course, the Faster R-CNN network processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the Faster R-CNN network processing system are readily contemplated by one of ordinary skill in the art given the teachings of the present invention provided herein.

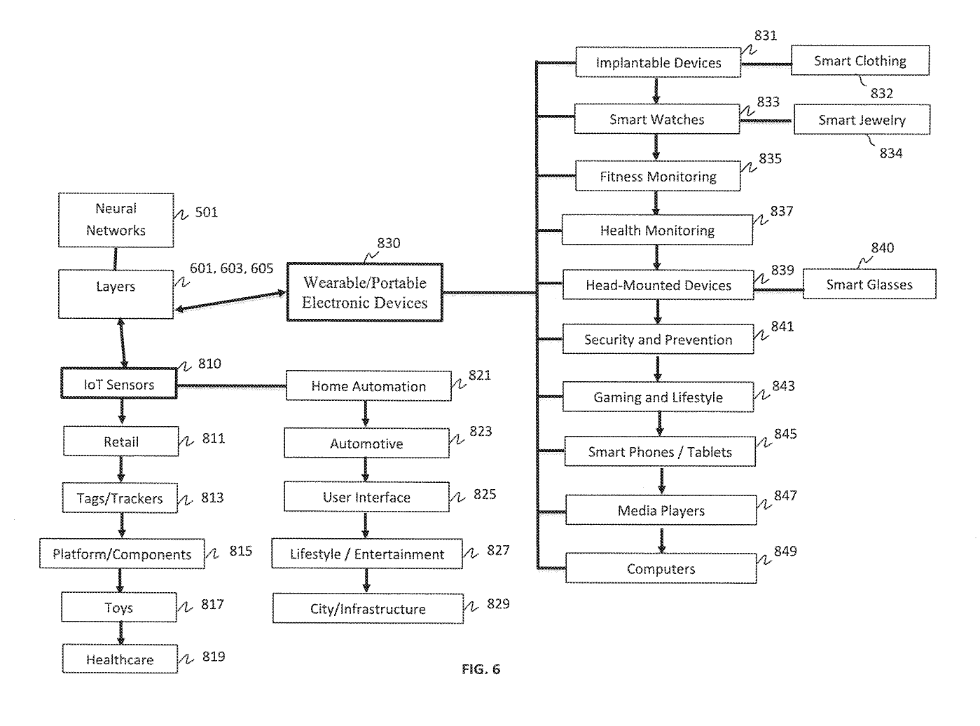

FIG. 6 is a block/flow diagram of a method for training fast models for real-time object detection with knowledge transfer in Internet of Things (IoT) systems/devices/infrastructure, in accordance with embodiments of the present invention.

According to some embodiments of the invention, an advanced neural network is implemented using an IoT methodology, in which a large number of ordinary items are utilized as the vast infrastructure of a neural network.

IoT enables advanced connectivity of computing and embedded devices through internet infrastructure. IoT involves machine-to-machine communications (M2M), where it is important to continuously monitor connected machines to detect any anomaly or bug, and resolve them quickly to minimize downtime.

The neural network 501 can be incorporated, e.g., into wearable, implantable, or ingestible electronic devices and Internet of Things (IoT) sensors. The wearable, implantable, or ingestible devices can include at least health and wellness monitoring devices, as well as fitness devices. The wearable, implantable, or ingestible devices can further include at least implantable devices, smart watches, head-mounted devices, security and prevention devices, and gaming and lifestyle devices. The IoT sensors can be incorporated into at least home automation applications, automotive applications, user interface applications, lifestyle and/or entertainment applications, city and/or infrastructure applications, toys, healthcare, fitness, retail tags and/or trackers, platforms and components, etc. The neural network 501 described herein can be incorporated into any type of electronic devices for any type of use or application or operation.

IoT (Internet of Things) is an advanced automation and analytics system which exploits networking, sensing, big data, and artificial intelligence technology to deliver complete systems for a product or service. These systems allow greater transparency, control, and performance when applied to any industry or system.

IoT systems have applications across industries through their unique flexibility and ability to be suitable in any environment. IoT systems enhance data collection, automation, operations, and much more through smart devices and powerful enabling technology.

IoT systems allow users to achieve deeper automation, analysis, and integration within a system. IoT improves the reach of these areas and their accuracy. IoT utilizes existing and emerging technology for sensing, networking, and robotics. Features of IoT include artificial intelligence, connectivity, sensors, active engagement, and small device use. In various embodiments, the neural network 501 of the present invention can be incorporated into a variety of different devices and/or systems. For example, the neural network 501 can be incorporated into wearable or portable electronic devices 830. Wearable/portable electronic devices 830 can include implantable devices 831, such as smart clothing 832. Wearable/portable devices 830 can include smart watches 833, as well as smart jewelry 834. Wearable/portable devices 830 can further include fitness monitoring devices 835, health and wellness monitoring devices 837, head-mounted devices 839 (e.g., smart glasses 840), security and prevention systems 841, gaming and lifestyle devices 843, smart phones/tablets 845, media players 847, and/or computers/computing devices 849.

The neural network 501 of the present invention can be further incorporated into Internet of Thing (IoT) sensors 810 for various applications, such as home automation 821, automotive 823, user interface 825, lifestyle and/or entertainment 827, city and/or infrastructure 829, retail 811, tags and/or trackers 813, platform and components 815, toys 817, and/or healthcare 819. The IoT sensors 810 can communicate with the neural network 501. Of course, one skilled in the art can contemplate incorporating such neural network 501 formed therein into any type of electronic devices for any types of applications, not limited to the ones described herein.

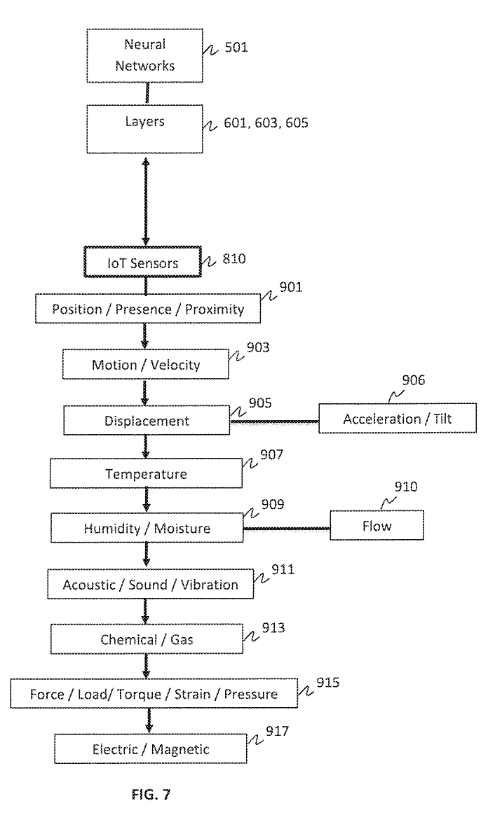

FIG. 7 is a block/flow diagram of exemplary IoT sensors used to collect data/information related to training fast models for real-time object detection with knowledge transfer, in accordance with embodiments of the present invention.

IoT loses its distinction without sensors. IoT sensors act as defining instruments which transform IoT from a standard passive network of devices into an active system capable of real-world integration.

The IoT sensors 810 can be connected via neural network 501 to transmit information/data, continuously and in real-time, to any type of neural network 501. Exemplary IoT sensors 810 can include, but are not limited to, position/presence/proximity sensors 901, motion/velocity sensors 903, displacement sensors 905, such as acceleration/tilt sensors 906, temperature sensors 907, humidity/moisture sensors 909, as well as flow sensors 910, acoustic/sound/vibration sensors 911, chemical/gas sensors 913, force/load/torque/strain/pressure sensors 915, and/or electric/magnetic sensors 917. One skilled in the art can contemplate using any combination of such sensors to collect data/information and input into the layers 601, 603, 605 of the neural network 501 for further processing. One skilled in the art can contemplate using other types of IoT sensors, such as, but not limited to, magnetometers, gyroscopes, image sensors, light sensors, radio frequency identification (RFID) sensors, and/or micro flow sensors. IoT sensors can also include energy modules, power management modules, RF modules, and sensing modules. RF modules manage communications through their signal processing, WiFi, ZigBee®, Bluetooth®, radio transceiver, duplexer, etc.

Moreover data collection software can be used to manage sensing, measurements, light data filtering, light data security, and aggregation of data. Data collection software uses certain protocols to aid IoT sensors in connecting with real-time, machine-to-machine networks. Then the data collection software collects data from multiple devices and distributes it in accordance with settings. Data collection software also works in reverse by distributing data over devices. The system can eventually transmit all collected data to, e.g., a central server.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method executed by at least one processor for training fast models for real-time object detection with knowledge transfer, the method comprising:
employing a Faster Region-based Convolutional Neural Network (R-CNN) as an objection detection framework for performing the real-time object detection;
inputting a plurality of images into the Faster R-CNN; and
training the Faster R-CNN by learning a student model from a teacher model by:
employing a weighted cross-entropy loss layer for classification accounting for an imbalance between background classes and object classes;
employing a boundary loss layer to enable transfer of knowledge of bounding box regression from the teacher model to the student model; and
employing a confidence-weighted binary activation loss layer to train intermediate layers of the student model to achieve similar distribution of neurons as achieved by the teacher model.

2. The method of claim 1, further comprising adopting hint-based learning that enables a feature representation of the student model to be similar to a feature representation of the teacher model.

3. The method of claim 2, further comprising enabling the hint-based learning to provide hints to the student model for finding local minima.

4. The method of claim 1, further comprising applying a larger weight for the background classes and a smaller weight for the object classes in the weighted cross-entropy loss layer.

5. The method of claim 1, further comprising setting a prediction vector of the bounding box regression to approximate a class label in the boundary loss layer.

6. The method of claim 1, further comprising allowing the student model to learn from a bounding box location of the teacher model in the boundary loss layer.

7. The method of claim 1, further comprising applying a positive gradient to the intermediate layers of the student model when a confidence of the teacher model is greater than a confidence of the student model in the confidence-weighted binary activation loss layer.

8. A system for training fast models for real-time object detection with knowledge transfer, the system comprising:
a memory; and
a processor in communication with the memory, wherein the processor runs program code to:
employ a Faster Region-based Convolutional Neural Network (R-CNN) as an objection detection framework for performing the real-time object detection;
input a plurality of images into the Faster R-CNN; and
train the Faster R-CNN by learning a student model from a teacher model by:
employing a weighted cross-entropy loss layer for classification accounting for an imbalance between background classes and object classes;
employing a boundary loss layer to enable transfer of knowledge of bounding box regression from the teacher model to the student model; and
employing a confidence-weighted binary activation loss layer to train intermediate layers of the student model to achieve similar distribution of neurons as achieved by the teacher model.

9. The system of claim 8, wherein hint-based learning is adopted that enables a feature representation of the student model to be similar to a feature representation of the teacher model.

10. The system of claim 9, wherein the hint-based learning is enabled to provide hints to the student model for finding local minima.

11. The system of claim 8, wherein a larger weight is applied for the background classes and a smaller weight is applied for the object classes in the weighted cross-entropy loss layer.

12. The system of claim 8, wherein a prediction vector of the bounding box regression is set to approximate a class label in the boundary loss layer.

13. The system of claim 8, wherein the student model is permitted to learn from a bounding box location of the teacher model in the boundary loss layer.

14. The system of claim 8, wherein a positive gradient is applied to the intermediate layers of the student model when a confidence of the teacher model is greater than a confidence of the student model in the confidence-weighted binary activation loss layer.

15. A non-transitory computer-readable storage medium comprising a computer-readable program for training fast models for real-time object detection with knowledge transfer, wherein the computer-readable program when executed on a computer causes the computer to perform the steps of:
employing a Faster Region-based Convolutional Neural Network (R-CNN) as an objection detection framework for performing the real-time object detection;
inputting a plurality of images into the Faster R-CNN; and
training the Faster R-CNN by learning a student model from a teacher model by:
employing a weighted cross-entropy loss layer for classification accounting for an imbalance between background classes and object classes;
employing a boundary loss layer to enable transfer of knowledge of bounding box regression from the teacher model to the student model; and
employing a confidence-weighted binary activation loss layer to train intermediate layers of the student model to achieve similar distribution of neurons as achieved by the teacher model.

16. The non-transitory computer-readable storage medium of claim 15, wherein hint-based learning is adopted that enables a feature representation of the student model to be similar to a feature representation of the teacher model.

17. The non-transitory computer-readable storage medium of claim 16, wherein the hint-based learning is enabled to provide hints to the student model for finding local minima.

18. The non-transitory computer-readable storage medium of claim 15, wherein a larger weight is applied for the background classes and a smaller weight is applied for the object classes in the weighted cross-entropy loss layer.

19. The non-transitory computer-readable storage medium of claim 15, wherein a prediction vector of the bounding box regression is set to approximate a class label in the boundary loss layer.

20. The non-transitory computer-readable storage medium of claim 15, wherein the student model is permitted to learn from a bounding box location of the teacher model in the boundary loss layer.
